(19) United States
(12) Patent Application Publication
(10) Pub. No.: US 2010/0185441 A1
(43) Pub. Date: Jul. 22, 2010

(54) Error Concealment

(75) Inventors: Xuejing Sun, Rochester Hills, MI (US); Kuan-Chieh Yen, Northville, MI (US)

Correspondence Address: NOVAK DRUCE DELUCA + QUIGG LLP, 1300 EYE STREET NW, SUITE 1000 WEST TOWER, WASHINGTON, DC, 20005, US

(73) Assignee: CAMBRIDGE SILICON RADIO LIMITED, Cambridge (GB)

(21) Appl. No.: 12/359,036

(22) Filed: Jan. 23, 2009

Related U.S. Application Data
(63) Continuation-in-part of application No. 12/356,631, filed on Jan. 21, 2009, now abandoned.

(51) Int. Cl. G10L 11/04

(52) U.S. Cl. 704/207; 704/E11.006

(57) ABSTRACT

A method of updating a state of a decoder that decodes successive portions of a data stream representing an encoded voice signal in dependence on its state, the method comprising: at the decoder, decoding portions of the data stream to form decoded portions; storing the decoded portions; storing respective decoder states held by the decoder after forming each decoded portion; identifying that a portion of the data stream is degraded; estimating a pitch period of a stored decoded portion formed by decoding a portion of the data stream that precedes the degraded portion of the data stream; selecting a stored decoder state held by the decoder after decoding a portion of the data stream that precedes the degraded portion by a multiple of the estimated pitch period; and updating the state of the decoder with the selected decoder state.

### CROSS-REFERENCE TO RELATED APPLICATION

This application is a continuation-in-part of copending application Ser. No. 12/356,631 filed 21 Jan. 2009, pursuant to 35 U.S.C. §120.

### FIELD OF THE INVENTION

This invention relates to updating the state of a decoder that decodes successive portions of a data stream in dependence on its state. The present invention is particularly applicable to updating the state of a decoder that decodes a data stream representing an encoded voice signal in which a portion of the data stream is degraded.

### BACKGROUND OF THE INVENTION

Wireless and voice-over-internet protocol (VoIP) communications are subject to frequent degradation of packets as a result of adverse connection conditions. The degraded packets may be lost or corrupted (comprise an unacceptably high error rate). Such degraded packets result in clicks and pops or other artefacts being present in the output voice signal at the receiving end of the connection. This degrades the perceived speech quality at the receiving end and may render the speech unrecognisable if the packet degradation rate is sufficiently high.

Broadly speaking, two approaches are taken to combat the problem of degraded packets. The first approach is the use of transmitter-based recovery techniques. Such techniques include retransmission of degraded packets, interleaving the contents of several packets to disperse the effect of packet degradation, and addition of error correction coding bits to the transmitted packets such that degraded packets can be reconstructed at the receiver. In order to limit the increased bandwidth requirements and delays inherent in these techniques, they are often employed such that degraded packets can be recovered if the packet degradation rate is low, but not all degraded packets can be recovered if the packet degradation rate is high. Additionally, some transmitters may not have the capacity to implement transmitter-based recovery techniques.

The second approach taken to combating the problem of degraded packets is the use of receiver-based concealment techniques. Such techniques are generally used in addition to transmitter-based recovery techniques to conceal any remaining degradation left after the transmitter-based recovery techniques have been employed. Additionally, they may be used in isolation if the transmitter is incapable of implementing transmitter-based recovery techniques. Low complexity receiver-based concealment techniques such as filling in a degraded packet with silence, noise, or a repetition of the previous packet are used, but result in a poor quality output voice signal. Regeneration based schemes such as model-based recovery (in which speech on either side of the degraded packet is modelled to generate speech for the degraded packet) produce a very high quality output voice signal but are highly complex, consume high levels of power and are expensive to implement. In practical situations interpolation-based techniques are preferred. These techniques generate a replacement packet by interpolating parameters from the packets on one or both sides of the degraded packet. These techniques are relatively simple to implement and produce an output voice signal of reasonably high quality.

Pitch based waveform substitution is a preferred interpolation-based packet degradation recovery technique. Voice signals appear to be composed of a repeating segment when viewed over short time intervals. This segment repeats periodically with a time period referred to as a pitch period. In pitch based waveform substitution, the pitch period of the voiced packets on one or both sides of the degraded packet is estimated. A waveform of the estimated pitch period is then repeated and used as a substitute for the degraded packet. This technique is effective because the pitch period of the degraded voice packet will normally be substantially the same as the pitch period of the voice packets on either side of the degraded packet.

Waveform substitution can be a very effective packet degradation concealment method for simple coding schemes that do not require use of a memory in order to decode a data stream, for example pulse code modulation (PCM). However, waveform substitution as it is described above is unable to fully address packet degradation problems in some codecs that rely on properties of the decoder in addition to the received data stream in order to decode the data stream. In particular, it is unable to fully address packet degradation problems in codecs that use an internal state held by the decoder after it has decoded a packet of data in order to decode the next packet of data, in addition to using the encoded data in the next packet of data. Examples of such codecs are continuously variable slope delta modulation (CVSD) and adaptive delta pulse code modulation (ADPCM).

If the decoder is used to decode a degraded packet that has been encoded using such a codec, then the decoder generates an erroneous output that does not correspond to the packet prior to its being encoded at the transmitting end of the connection. Additionally, the decoder is left holding an internal state that is dependent on the degraded packet. This internal state is not the correct state for decoding the next packet of data. Consequently the next packet, even if received in an adequate condition, is incorrectly decoded by the decoder. If a packet concealment method is used to generate a decoded output for the degraded packet then the decoded output is not erroneous. However if a packet concealment method is used then the decoder need not be used in which case the internal state of the decoder is not updated to the state required to decode the next packet of data. Consequently the next packet, even if received in an adequate condition, is incorrectly decoded by the decoder. The error in the decoder state propagates through subsequent decoding steps. Subsequent packets are therefore additionally incorrectly decoded as a result of the propagation of the error in the decoder state.

If the decoder holds incorrect internal states when it decodes data packets, undesirable artefacts result in the output voice signal. Updating the decoder state to the correct decoder state for the data packet being decoded is therefore important for providing an acceptable quality output voice signal.

Several approaches have been taken to solve the problem of updating the internal state of the decoder when a degraded packet has been received.

U.S. patent application Ser. No. 11/838,895, incorporated by reference herein, discloses synthesizing decoded data for the degraded packet using a packet concealment method. The synthesized decoded data is then re-encoded using an encoder. The re-encoded synthesized data is then passed through the decoder such that the decoder is left in the correct state for decoding the next packet of data. The additional encoding and decoding steps incur extra computational complexity and hence significantly increase the processing power of the decoder method. Consequently, this method lacks efficiency.

U.S. Pat. No. 7,206,986, also incorporated by reference herein, discloses a more efficient method of updating the state of the decoder. The apparatus of this patent is depicted in FIG. 1. Received encoded data on line 101 is checked for errors at block 102. If an error is indicated then the switch 103 connects input 104 to output 105. The switch output 105 is connected to CVSD decoder 106. The switch output 105 is also connected to buffer 107. The buffer 107 stores encoded data that is output by the switch to the decoder 106. If an error is detected by block 102 then the pitch period of the data decoded prior to the error is estimated at block 108. The encoded data in buffer 107 is looped to the switch input 104 with a delay that is set in dependence on the pitch period estimated by block 108. The switch 103 feeds the buffered data to the decoder 106 as a substitute for the corrupted packet comprising the error. The decoder decodes the buffered data and outputs a signal which is used as the decoded output for the corrupted packet. The decoder 106 is left holding an internal state suitable for decoding the next packet of encoded data. This method is more efficient that the method described in the previous paragraph because it does not require decoded data to be re-encoded in order to update the state of the decoder. However, this method does require that data that has previously been decoded be decoded a second time in order to update the state of the decoder.

There is thus a need for an improved method of updating the state of a decoder when a degraded packet is received that reduces the computational complexity involved by removing the requirement that a packet be decoded in order to update the state of the decoder.

### SUMMARY OF THE INVENTION

According to a first aspect of the invention, there is provided a method of updating a state of a decoder that decodes successive portions of a data stream representing an encoded voice signal in dependence on its state, the method comprising: at the decoder, decoding portions of the data stream to form decoded portions; storing the decoded portions; storing respective decoder states held by the decoder after forming each decoded portion; identifying that a portion of the data stream is degraded; estimating a pitch period of a stored decoded portion formed by decoding a portion of the data stream that precedes the degraded portion of the data stream; selecting a stored decoder state held by the decoder after decoding a portion of the data stream that precedes the degraded portion by a multiple of the estimated pitch period; and updating the state of the decoder with the selected decoder state.

Suitably, the method comprises identifying that a portion of the data stream is degraded by measuring an error rate for that portion of the data stream and determining that the measured error rate exceeds a threshold error rate.

Suitably, the method further comprises after identifying that a portion of the data stream is degraded: inhibiting the decoder from decoding the degraded portion; and enabling a concealment module to perform the estimating, selecting and updating steps.

Suitably, the method comprises estimating a pitch period of a stored decoded portion formed by decoding the portion of the data stream that immediately precedes the degraded portion of the data stream.

Suitably the method comprises, if the estimated pitch period is greater than or equal to the length of the portions of the data stream, selecting a stored decoder state held by the decoder after decoding a portion of the data stream that precedes the degraded portion by the estimated pitch period.

Suitably the method comprises, if the estimated pitch period is less than the length of the portions of the data stream, selecting a stored decoder state held by the decoder after decoding a portion of the data stream that precedes the degraded portion by the smallest multiple of the estimated pitch period that is greater than or the same as the length of the portions of the data stream.

Suitably the method further comprises prior to updating the state of the decoder with the selected decoder state, adjusting the selected decoder state in dependence on the relationship between a first decoder state and a second decoder state, the first decoder state being that held by the decoder after decoding the portion of the data stream immediately preceding the degraded portion, and the second decoder state being that held by the decoder prior to the first decoder state being held by the decoder by the estimated pitch period.

Suitably the method further comprises generating a decoded portion corresponding to the degraded portion of the data stream by: selecting a sample of the stored decoded portions formed by decoding a portion of the data stream that precedes the degraded portion by a multiple of the estimated pitch period; and forming the decoded portion corresponding to the degraded portion of the data stream from the selected sample and samples successive to the selected sample.

According to a second aspect of the invention, there is provided a decoder state update apparatus comprising: a decoder configured to decode successive portions of a data stream representing an encoded voice signal in dependence on its state to form decoded portions; a first buffer configured to store the decoded portions; a second buffer configured to store respective decoder states held by the decoder after forming each decoded portion; a degradation detector configured to identify that a portion of the data stream is degraded; a pitch period estimation module configured to estimate a pitch period of a stored decoded portion formed by decoding a portion of the data stream that precedes the degraded portion of the data stream; and a decoder state update module configured to select a stored decoder state held by the decoder after decoding a portion of the data stream that precedes the degraded portion by a multiple of the estimated pitch period, and to update the state of the decoder with the selected decoder state.

Suitably the apparatus further comprises a switch configured to connect and disconnect the data stream to the decoder, the switch being controllable by the degradation detector so as to inhibit the decoder from decoding the degraded portion.

Suitably, the apparatus further comprises a replacement module configured to receive the estimated pitch period and generate a decoded portion corresponding to the degraded portion of the data stream by: selecting a sample of the stored decoded portions formed by decoding a portion of the data stream that precedes the degraded portion by a multiple of the estimated pitch period; and forming the decoded portion corresponding to the degraded portion of the data stream from the selected sample and samples successive to the selected sample.

### BRIEF DESCRIPTION OF THE DRAWINGS

The present invention will now be described by way of example with reference to the accompanying drawings. In the drawings:

FIG. 1 is a schematic diagram of a prior art decoding apparatus;

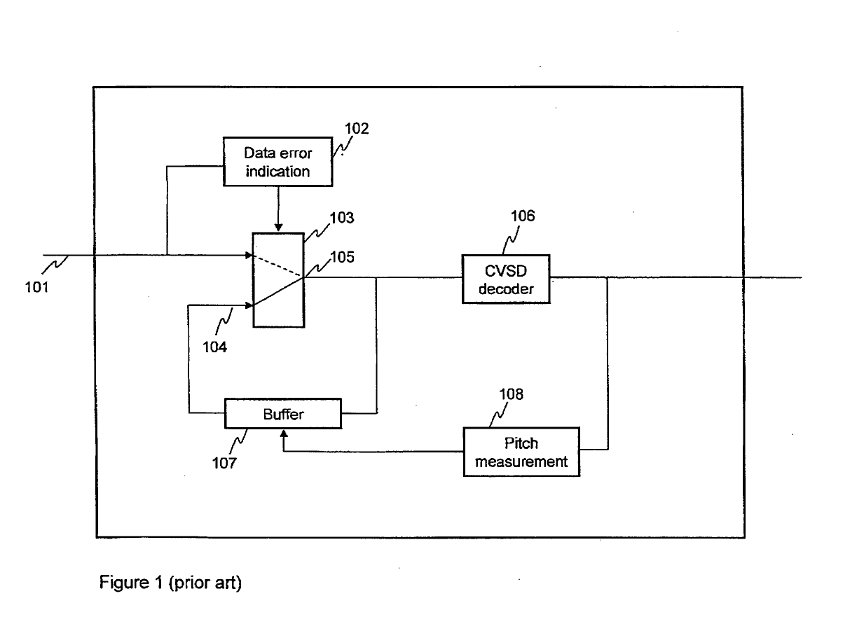

FIG. 2 is a schematic diagram of a decoding apparatus according to the present invention;

FIG. 2a is a schematic diagram of an alternate decoding apparatus according to the present invention;

FIG. 3 is a graph of a typical voice signal illustrating a cross-correlation method;

FIG. 4 is an illustration of the time relationship between the state to be updated and the decoder states in the decoder state buffer;

FIG. 5 is a flow chart of a decoding method according to the present invention; and

FIG. 6 is a schematic diagram of a transceiver suitable for comprising the decoding apparatus of FIG. 2.

### DESCRIPTION OF THE PREFERRED EMBODIMENTS

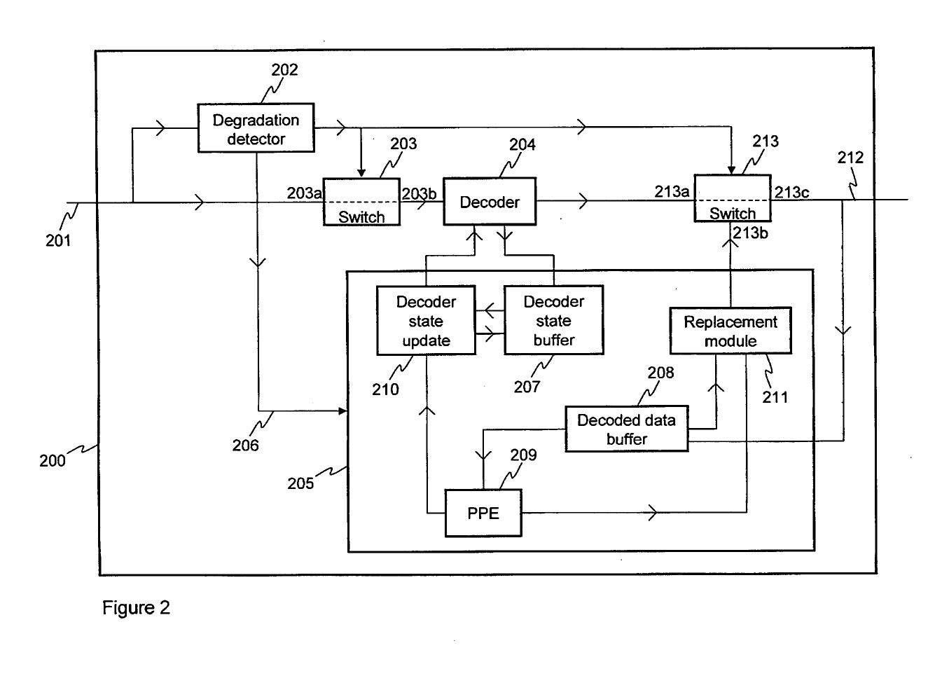

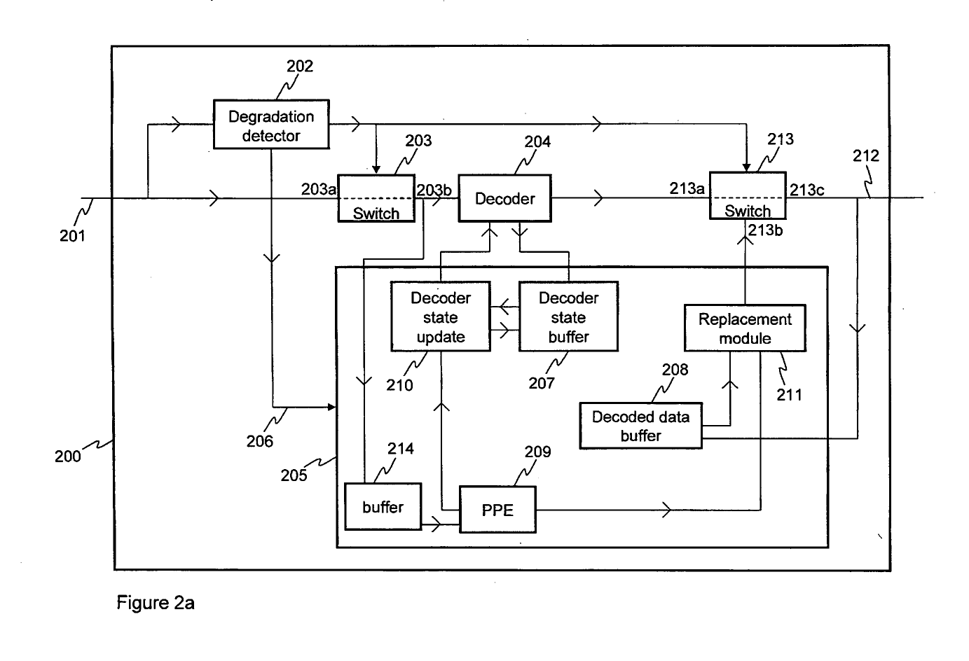

FIG. 2 shows a schematic diagram of the general arrangement of a decoding apparatus. On FIG. 2, solid arrows terminating at a module indicate control signals. Other arrows indicate the direction of travel of signals between the modules.

An encoded data stream is input to the decoding apparatus 200 on line 201. Line 201 is connected to an input of degradation detector 202. A first control output of degradation detector 202 is connected to an input of switch 203. Line 201 is connected to a further input of switch 203. An output of switch 203 is connected to a first input of decoder 204. A first output of decoder 204 is connected to a first input of switch 213. A second control output of degradation detector 202 is connected to a second input of switch 213. A first output of switch 213 connected to an output of the decoding apparatus 200 on line 212. The decoding apparatus further comprises a degradation concealment module 205. A third control output of degradation detector 202 is connected to a control input of degradation concealment module 205 on line 206. Degradation concealment module 205 comprises a decoder state buffer 207, a decoded data buffer 208, a pitch period estimation module 209, a decoder state update module 210 and a replacement module 211. A second output of the decoder 204 is connected to an input of decoder state buffer 207. An output of decoder state buffer 207 is connected to an input of decoder state update module 210. A first output of decoder state update module 210 is connected to a second input of decoder state buffer 207. A second output of decoder state update module 210 is connected to a second input of decoder 204. The first output of switch 213 on line 212 is connected to an input of decoded data buffer 208. A first output of decoded data buffer 208 is connected to an input of the pitch period estimation module 209. A second output of decoded data buffer 208 is connected to a first input of replacement module 211. A first output of pitch period estimation module 209 is connected to a second input of decoder state update module 210. A second output of pitch period estimation module 209 is connected to a second input of replacement module 211. An output of replacement module 211 is connected to a third input of switch 213.

In operation, signals are processed by the decoding apparatus of FIG. 2 in discrete temporal parts. The following description refers to processing packets of data, however the description applies equally to processing frames of data or any other suitable portions of data. These portions of data are generally of the order of a few milliseconds in length.

Each packet of the voice signal is sequentially input into the decoding apparatus 200 on line 201. Each packet is input to the degradation detector 202. For each packet, the degradation detector 202 determines whether to generate a decoded output from the decoding apparatus by decoding the packet on line 201 or by generating a replacement packet using the degradation concealment module 205.

Some communication protocols provide coding mechanisms for error detection and/or error correction, for example cyclic redundancy checks (CRC). If the decoding apparatus 200 is operating in accordance with such a protocol, the degradation detector 202 may use the error detection and/or error correction method of the protocol in its determination of whether to decode the packet or generate a replacement packet.

If the decoding apparatus 200 is operating in accordance with a protocol that does not provide a coding mechanism for error detection and/or error correction, then the degradation detector 202 may base its determination of whether to decode the packet or generate a replacement packet on the error rate of the received data. For example, the degradation detector 202 may measure the error rate of the received packet. If the error rate is lower than a threshold value then the degradation detector determines that the packet is not degraded and is to be decoded using the decoder 204. However, if the error rate is higher than the threshold value then the degradation detector determines that the packet is degraded and that the degradation concealment module 205 is to be used to generate a decoded output for the degraded packet. The threshold error value may be predetermined. Alternatively, the threshold error value may be dynamically determined during receipt of the signal. The use of determining the error rate of the received data as described here may be used even if the communication protocol allows for error detection and/or error correction.

The apparatus and method described herein are suitable for implementation in Bluetooth devices. Some Bluetooth packet types include a CRC after the packet payload that is used to detect most of the errors in the received packet. However, CRC is limited in that if there are errors in a packet it can only indicate that there are errors in the packet: it provides no information on the location of the errors or on the degree of degradation. A packet is also degraded if it has been lost before or on reception at the receiver. In Bluetooth, packets comprise a header portion preceding the payload portion. A Header Error Check (HEC) is performed on the header. This is an 8-bit CRC. The packet is discarded if its header check fails.

If the packet is not degraded, then the degradation detector 202 outputs a control signal to switch 203 which controls the switch 203 to connect input 203a to output 203b, thereby passing the packet on line 201 through to decoder 204. Additionally, the degradation detector 202 outputs a second control signal to switch 213 which controls the switch 213 to connect input 213a to output 213c, thereby connecting the output of the decoder 204 to the output of the decoding apparatus 200 on line 212. If the packet is degraded, then the degradation detector 202 outputs a control signal on line 206 to the degradation concealment module 205 controlling it to generate a replacement packet and update the state of the decoder. If the packet is degraded then the degradation detector 202 does not control the switch 203 to connect input 203a to output 203b. The degraded packet is therefore not connected to decoder 204. In this case, the degradation detector 202 controls the switch 213 to connect input 213b to output 213c, thereby connecting the output of the degradation concealment module 205 to the output of the decoding apparatus 200 on line 212. If the packet is not degraded then the degradation detector 202 does not control the degradation concealment module 205 to generate a replacement packet or to update the decoder state.

If the packet is not degraded then the switch 203 switches the packet through to the first input of decoder 204. The decoder 204 decodes the packet using the appropriate coding scheme and outputs the decoded packet to switch 213. Switch 213 receives the decoded packet at input 213a and outputs it from output 213c on line 212. The decoded packet on line 212 is input to decoded data buffer 208 where it is stored. This decoded packet is also output from the decoding apparatus 200 as the decoded output. As a result of decoding the packet, the decoder is left holding the correct state required to decode the next packet of data. This state is output to decoder state buffer 207 where it is stored.

If the packet is degraded then the switch 203 is not enabled by the control input from degradation detector 202 to connect input 203a to output 203b. Consequently, no packet is passed through decoder 204. The degradation detector 202 outputs a control signal on line 206 that enables the degradation concealment module 205 to generate a replacement packet and update the state of the decoder. This control signal enables decoded data buffer 208 to output the most recently decoded packet or packets (or replacement packet or packets) to the pitch period estimation module 209. The pitch period estimation module 209 estimates the pitch period of the packet or packets it receives.

The pitch period estimation module 209 could estimate the pitch period of the most recently decoded packet or packets by estimating the pitch period of the encoded packet or packets before they are decoded by the decoder 204. This is illustrated in FIG. 2a. The encoded packet or packets output by switch 203 are input to a buffer 214. The encoded packet or packets may be stored at the buffer 214 before being output to the pitch period estimation module 209. The pitch period estimation module 209 estimates the pitch period of the packet or packets.

Many methods may be used to estimate the pitch period of a voice signal. Generally speaking, these methods include use of a normalised cross-correlation (NCC) method. Such a method can be expressed mathematically as:

$${NCC}_{t} ( τ ) = \frac{{\sum }_{n = - N / 2}^{( N / 2 ) - 1} x [ t + n ] x [ t + n - τ ]}{\sqrt{{\sum }_{n = - N / 2}^{( N / 2 ) - 1} {x}^{2} [ t + n ] {\sum }_{n = - N / 2}^{( N / 2 ) - 1} {x}^{2} [ t + n - τ ]}} \qquad ( equation 1 )$$

where x is the amplitude of the voice signal and t is time. The equation represents a correlation between two segments of the voice signal which are separated by a time τ. Each of the two segments is split up into N samples. The nth sample of the first segment is correlated against the respective nth sample of the other segment.

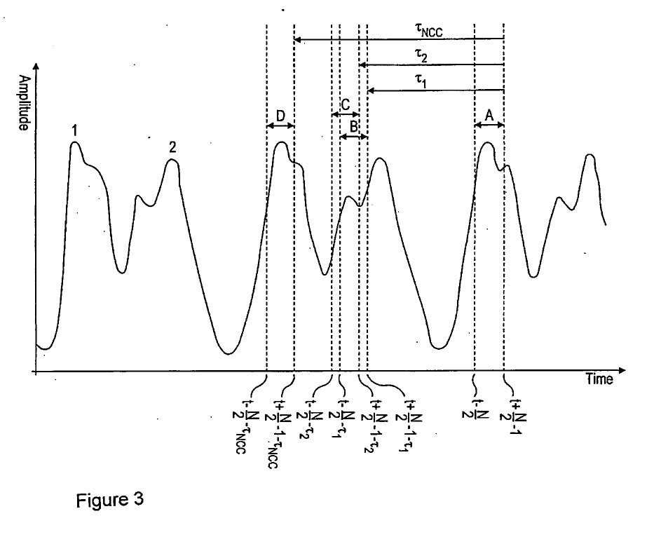

This equation essentially takes a first segment of a signal (marked A on FIG. 3) and correlates it with each of a number of further segments of the signal (for ease of illustration only three, marked B, C and D, are shown on FIG. 3). Each of these further segments lags the first segment along the time axis by a lag value (τ₁ for segment B, τ₂ for segment C). The calculation is carried out over a range of lag values within which the pitch period of the voice signal is expected to be found. The term on the bottom of the fraction in equation 1 is a normalising factor. The lag value τ_{NCC} that maximises the NCC function represents the time interval between the segment A and the segment with which it is most highly correlated (segment D on FIG. 3). This lag value τ_{NCC} is taken to be the pitch period of the signal.

The pitch period estimation module 209 outputs the estimated pitch period to the replacement module 211. The replacement module 211 selects decoded data from the decoded data buffer 208 in dependence on the estimated pitch period. The selected decoded data is used as a decoded replacement for the degraded packet. The replacement module 211 outputs the decoded replacement packet to input 213b of switch 213. Switch 213 is enabled under the control of degradation detector 202 to connect input 213b to output 213c thereby outputting the decoded replacement packet on line 212 for output from the decoding apparatus 200. The decoded replacement packet on line 212 is input to decoded data buffer 208 where it is stored.

Suitably, the replacement module 211 performs a pitch-based waveform substitution. Suitably, this involves generating a waveform at the pitch period estimated by the pitch period estimation module 209. The waveform is repeated as a replacement for the degraded packet. If the lost packet is shorter than the estimated pitch period, then the generated waveform is a fraction of the length of the estimated pitch period. Suitably, the generated waveform is slightly longer than the degraded packet, such that it overlaps with the packets on either side of the degraded packet. The overlaps are advantageously used to fade the generated waveform of the degraded packet into the received signal on either side thereby achieving smooth concatenation.

The replacement module 211 generates the waveform using the decoded data stored sequentially in the decoded data buffer 208. This decoded data includes data decoded by the decoder 204 and replacement data generated by the degradation concealment module 205. Advantageously, the decoded data buffer 208 has a longer length (stores more samples) than the maximum pitch period (measured in samples). The replacement module counts back sequentially, from the most recently received sample in the decoded data buffer, by a number of samples equal to the estimated pitch period. The sample that the replacement module counts back to is taken to be the first sample of the generated waveform. The replacement module 211 takes sequential samples up to the number of samples that are in the degraded packet. The resulting selected set of samples is taken to be the generated waveform. For example, if the decoded data buffer has a length of 200 samples, the estimated pitch period is determined to have a length of 50 samples and the degraded packet has a length of 30 samples, then the replacement module 211 generates a waveform containing samples 151 to 180 of the decoded data buffer.

If the degraded packet is longer than the estimated pitch period, then the set of samples equal to the length of the estimated pitch period is selected (in the above example this would be samples 151 to 200). This set of samples is repeated and used as the generated waveform to replace the degraded packet. Alternatively, a set of samples equal to the length of the degraded packet is selected from the decoded data buffer 208. This is achieved by counting back sequentially in the decoded data buffer, from the most recently received sample, by a number of samples equal to a multiple of the estimated pitch period. The multiple is chosen such that the number of samples counted back is longer than or equal to (no shorter than) the length of the degraded packet. The multiple may, for example, be 1. Typically the multiple will be 2 or 3 times the estimated pitch period. The sample that the replacement module counts back to is taken to be the first sample of the generated waveform. The replacement module 211 takes sequential samples up to the number of samples that are in the degraded packet. The resulting selected set of samples is taken to be the generated waveform. For example, if the history buffer has a length of 200 samples, the estimated pitch period is determined to have a length of 50 samples and the degraded packet has a length of 60 samples, then the replacement module 211 generates a waveform containing samples 101 to 160 of the decoded data buffer.

Alternatively, other known pitch based waveform substitution techniques utilising the estimated pitch period may be used by the replacement module 211.

The pitch period estimation module 209 also outputs the estimated pitch period to the decoder state update module 210. In dependence on the estimated pitch period, the decoder state update module selects a decoder state from the decoder state buffer 207. The decoder state update module outputs the selected decoder state to the decoder 204. The decoder 204 sets the selected state to be the state it would have held had it decoded the degraded packet. The decoder uses the selected decoder state in decoding the next packet of encoded data after the degraded packet. The decoder state update module 210 also outputs the selected decoder state back to the decoder state buffer 207. The decoder state buffer 207 stores decoder states sequentially. It therefore stores the selected decoder state at a position corresponding to the missing state. This is at a position corresponding to the position at which the decoded replacement packet is stored in the decoded data buffer 208. Both the selected decoder state and the decoded replacement packet are therefore used by the degradation concealment module 205 in handling future degraded packets in the same manner as data that has been decoded by the decoder and decoder states that have been held by the decoder.

The decoder state update module 210 selects a decoder state from the decoder state buffer 207 that has a time lag with the ending state of the degraded packet corresponding to the estimated pitch period or a multiple integer of the estimated pitch period.

As an example, consider the use of a Bluetooth CVSD codec with a packet length (L) of 240 bits. A bluetooth CVSD codec is sampled at 64 kHz and the input and output packet concealment waveform is sampled at 8 kHz.

Consequently, resampling is required prior to the CVSD encoder at the transmitting end of the communication and after the CVSD decoder at the receiving end of the communication. The pitch period estimation module 209 estimates the pitch period of the 8 kHz decoded data from the decoded data buffer 208 or alternatively from the encoded data buffer 214 as shown in FIG. 2a. Consider the case where the pitch period is estimated to be:

P_{decoded}=60 samples (equation 2)

This corresponds to a pitch period of:

P₀=60×8=480 bits (equation 3)

Since the ending state of the decoder is required, the decoder state update module 210 selects the decoder state that is located P₀−L bits from the end of the decoder state buffer. In this case:

Selected state=P₀−L=480−240=240 bits (equation 4)

If:

P₀−L<0, (equation 5)

then the decoder state update module 210 selects the decoder state that is located nP₀−L bits from the end of the decoder state buffer, where n is the smallest integer that satisfies:

nP₀−L>=0 (equation 6)

The minimum length of the decoder state buffer is Pmax−L, where Pmax is the maximum pitch period under consideration. Suitably, Pmax might be chosen to be 128×8 bits which corresponds to a pitch frequency of 62.5 kHz.

For a Bluetooth CVSD codec, there are two state values to consider. The first is the step size δ and the second is the reconstructed sample x. These two state values can be represented as a state vector, S:

S=[δ, x] (equation 7)

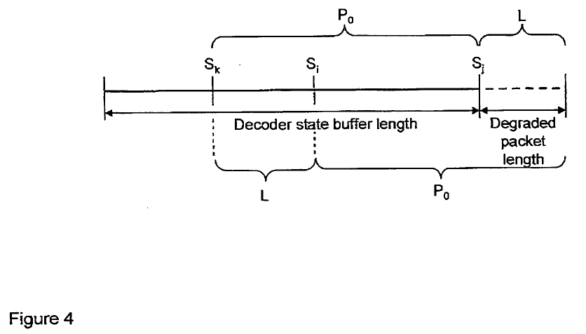

FIG. 4 illustrates the decoder states in the decoder state buffer. Sᵢ is the state vector selected to update the decoder, Sⱼ is the ending state vector before the degraded packet, Sₖ is the state vector that is one pitch period previous to Sⱼ, L is the length of the degraded packet and P₀ is the estimated pitch period.

In FIG. 4, the state vectors have the following values:

Sᵢ=[100, 200]

Sⱼ=[60, 110]

Sₖ=[120, 220] (equation 8)

Suitably, adjustments may be made to the selected state, Sᵢ, based on the relationship between the state just before the degraded packet, Sⱼ, and the state with the time lag of one pitch period from it, Sₖ. For example, the adjustments may be based on the difference or ratio between the states Sⱼ and Sₖ. Preferably, the adjusted selected state is stored in decoder state buffer 207 instead of the selected state. For example, if the estimated pitch period is long or the packet length is short then the selected state may be adjusted from Sᵢ to Sᵢ′ where:

$${S}_{i}^{′} = \frac{{S}_{j}}{{S}_{k}} {S}_{i} \qquad ( equation 9 )$$

In the example of FIG. 4, Sᵢ′=[50, 100].

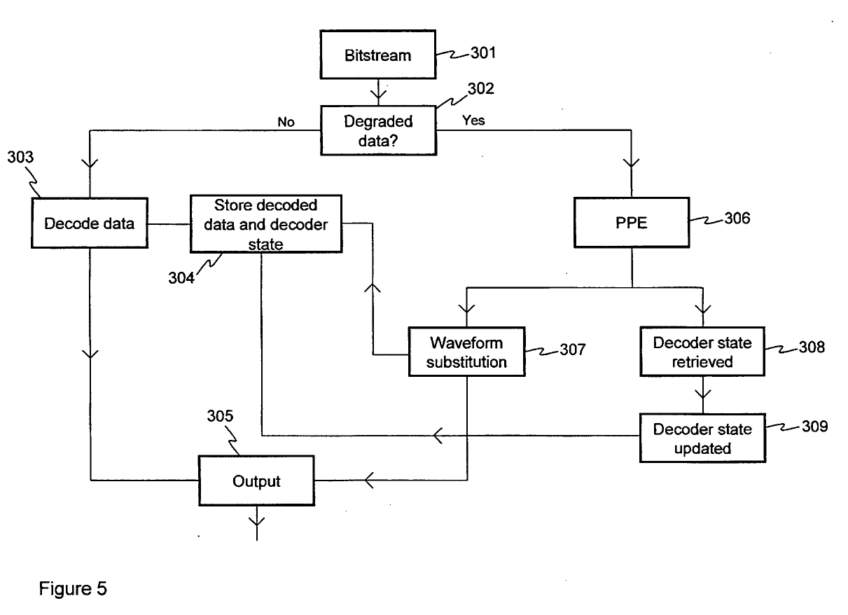

FIG. 5 shows a flow chart of the above described method. At step 301, the voice packet enters the decoding apparatus. At step 302 the degradation detector determines whether the packet is degraded. If the packet is not degraded, then the packet is decoded by the decoder at step 303. The decoded data and the state of the decoder after decoding the packet are stored at step 304. The decoded data is output from the decoding apparatus at step 305. If the packet is degraded, then the pitch period of the preceding packet or packets is estimated at step 306. Pitch-based waveform substitution is performed at step 307 to produce a replacement decoded waveform which is output from the decoding apparatus at step 305. The decoder state is retrieved by the decoder state update from the decoder state buffer at step 308 and passed to the decoder at step 309. The replacement data and decoder state are stored at step 304.

FIG. 2 is a schematic diagram of the decoding apparatus described herein. The method described does not have to be implemented at the dedicated blocks depicted in FIG. 2. The functionality of each block could be carried out by another one of the blocks described or using other apparatus. For example, the method described herein could be implemented partially or entirely in software.

The method described is useful for packet loss/error concealment techniques implemented in wireless voice or VoIP communications. The method is particularly useful for products such as some Bluetooth and Wi-Fi products that involve applications with coded audio transmissions such as music streaming and hands-free phone calls.

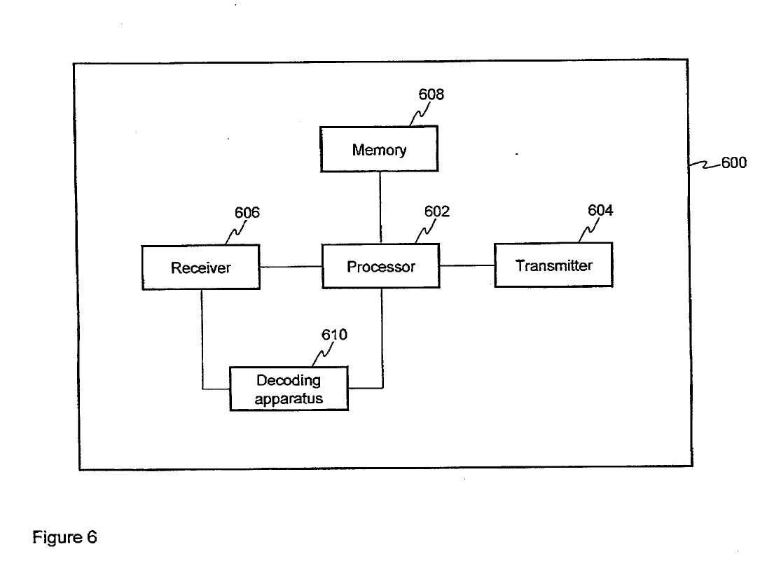

The pitch period estimation apparatus of FIG. 2 could usefully be implemented in a handheld transceiver. FIG. 6 illustrates such a transceiver 600. A processor 602 is connected to a transmitter 604, a receiver 606, a memory 608 and a decoding apparatus 610. Any suitable transmitter, receiver, memory and processor known to a person skilled in the art could be implemented in the transceiver. Preferably, the decoding apparatus 610 comprises the apparatus of FIG. 2. The decoding apparatus is additionally connected to the receiver 606. The signals received and demodulated by the receiver may be passed directly to the decoding apparatus for decoding.

Alternatively, the received signals may be stored in memory 608 before being passed to the decoding apparatus. The handheld transceiver of FIG. 6 could suitably be implemented as a wireless telecommunications device.

Prior systems decode data, for which the decoded form is already known, in order to update the state of the decoder. Some prior systems additionally encode data, for which the decoded form is already known, in order to update the state of the decoder. The method and apparatus described herein reduces the computational complexity associated with updating the state of a decoder when a degraded packet is received. This is because the method and apparatus described disclose updating the decoder with a suitable decoder state without decoding the input bit stream or re-encoding a synthesized waveform as in prior systems.

The method described herein advantageously stores states of the decoder during normal operation of the decoding apparatus, normal operation here meaning when the decoding apparatus decodes packets which are determined to be not degraded. The method also stores states of the decoder associated with degraded packets. When a degraded packet is received the decoder is not used to decode the degraded packet. However, it is desirable that the state of the decoder be updated to reduce errors associated with decoding future received packets. The method described advantageously selects an appropriate decoder state from the stored states and updates the decoder with the selected state. The method described advantageously selects a decoder state based on the estimated pitch period of the packet or packets preceding the degraded packet. If the next packet is received in an adequate condition then it will be correctly decoded since the decoder is holding the correct state to decode it. Since this pitch period is estimated for use in generating a replacement waveform for the degraded packet, no additional computational complexity is introduced by using the estimated pitch period.

The method described herein provides a method for updating the state of a decoder for use in packet loss/error concealment systems. The procedure significantly reduces artefacts and improves the packet loss/error concealment performance at high packet loss rate. The method is simple to implement and highly configurable. Unlike many prior systems, this is not a codec-specific method. The method described is independent of the codec used and hence can easily be ported to new codec platforms. Additionally, the method can be used in combination with a number of pitch period estimation algorithms.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of updating a state of a decoder that decodes successive portions of a data stream representing an encoded voice signal in dependence on its state, the method comprising:
at the decoder, decoding portions of the data stream to form decoded portions;
storing the decoded portions;
storing respective decoder states held by the decoder after forming each decoded portion;
identifying that a portion of the data stream is degraded;
estimating a pitch period of a stored decoded portion formed by decoding a portion of the data stream that precedes the degraded portion of the data stream;
selecting a stored decoder state held by the decoder after decoding a portion of the data stream that precedes the degraded portion by a multiple of the estimated pitch period; and
updating the state of the decoder with the selected decoder state.

2. A method as claimed in claim 1, comprising identifying that a portion of the data stream is degraded by measuring an error rate for that portion of the data stream and determining that the measured error rate exceeds a threshold error rate.

3. A method as claimed in claim 1, further comprising after identifying that a portion of the data stream is degraded:
inhibiting the decoder from decoding the degraded portion; and
enabling a concealment module to perform the estimating, selecting and updating steps.

4. A method as claimed in claim 1, comprising estimating a pitch period of a stored decoded portion formed by decoding the portion of the data stream that immediately precedes the degraded portion of the data stream.

5. A method as claimed in claim 1, comprising, if the estimated pitch period is greater than or equal to the length of the portions of the data stream, selecting a stored decoder state held by the decoder after decoding a portion of the data stream that precedes the degraded portion by the estimated pitch period.

6. A method as claimed in claim 1, comprising, if the estimated pitch period is less than the length of the portions of the data stream, selecting a stored decoder state held by the decoder after decoding a portion of the data stream that precedes the degraded portion by the smallest multiple of the estimated pitch period that is greater than or the same as the length of the portions of the data stream.

7. A method as claimed in claim 1, further comprising prior to updating the state of the decoder with the selected decoder state, adjusting the selected decoder state in dependence on the relationship between a first decoder state and a second decoder state, the first decoder state being that held by the decoder after decoding the portion of the data stream immediately preceding the degraded portion, and the second decoder state being that held by the decoder prior to the first decoder state being held by the decoder by the estimated pitch period.

8. A method as claimed in claim 1, further comprising generating a decoded portion corresponding to the degraded portion of the data stream by:
selecting a sample of the stored decoded portions formed by decoding a portion of the data stream that precedes the degraded portion by a multiple of the estimated pitch period; and
forming the decoded portion corresponding to the degraded portion of the data stream from the selected sample and samples successive to the selected sample.

9. A method as claimed in claim 1, comprising estimating a pitch period of a stored decoded portion formed by decoding a portion of the data stream that precedes the degraded portion of the data stream by estimating a pitch period of a portion of the data stream that precedes the degraded portion of the data stream.

10. A decoder state update apparatus comprising:
a decoder configured to decode successive portions of a data stream representing an encoded voice signal in dependence on its state to form decoded portions;
a first buffer configured to store the decoded portions;
a second buffer configured to store respective decoder states held by the decoder after forming each decoded portion;
a degradation detector configured to identify that a portion of the data stream is degraded;
a pitch period estimation module configured to estimate a pitch period of a stored decoded portion formed by decoding a portion of the data stream that precedes the degraded portion of the data stream; and
a decoder state update module configured to select a stored decoder state held by the decoder after decoding a portion of the data stream that precedes the degraded portion by a multiple of the estimated pitch period, and to update the state of the decoder with the selected decoder state.

11. An apparatus as claimed in claim 10, further comprising a switch configured to connect and disconnect the data stream to the decoder, the switch being controllable by the degradation detector so as to inhibit the decoder from decoding the degraded portion.

12. An apparatus as claimed in claim 10, further comprising a replacement module configured to receive the estimated pitch period and generate a decoded portion corresponding to the degraded portion of the data stream by:
selecting a sample of the stored decoded portions formed by decoding a portion of the data stream that precedes the degraded portion by a multiple of the estimated pitch period; and
forming the decoded portion corresponding to the degraded portion of the data stream from the selected sample and samples successive to the selected sample.
